(19) United States
(12) Patent Application Publication
(10) Pub. No.: US 2015/0228084 A1
(43) Pub. Date: Aug. 13, 2015

(54) SYSTEMS AND METHODS FOR CALCULATING FOOT SIZE USING IMAGE RECOGNITION

(71) Applicant: NETCOUTOURE, INC., Palo Alto, CA (US)

(72) Inventors: Sergey Belyaev, St. Petersburg (RU); Vladislav Shubnikov, St. Petersburg (RU); Sergey Balashov, St. Petersburg (RU); Yekaterina Stesin, Woodside, CA (US); Vladimir Abramov, Moscow (RU); Igor Shturts, St. Petersburg (RU)

(73) Assignee: NETCOUTOURE, INC., Palo Alto, CA (US)

(21) Appl. No.: 14/176,282

(22) Filed: Feb. 10, 2014

(51) Int. Cl. G06T 7/00; G01B 11/02; G06K 9/46; G06T 7/60; G06K 9/48; A43D 1/02; G01B 11/24

(52) U.S. Cl. CPC G06T 7/0089; A43D 1/025; G01B 11/02; G01B 11/24; G06T 7/60; G06K 9/48; G06K 9/4604; G06T 2207/30196

(57) ABSTRACT

A computer-implemented method for estimating a size of a foot comprising: receiving a plurality of images of the foot in relation to a sheet of paper; performing determination of a contour of the sheet of paper in the received plurality of images; using at least one of the received plurality of images to determine an internal contour of the foot; using at least second one of the received plurality of images to determine an external contour of the foot; using the determined internal contour of the foot and the determined external contour of the foot to calculate a horizontal contour of the foot and calculate a size of the horizontal contour of the foot; and using at least third one of the received plurality of images to determine an vertical contour of the foot and calculate a sizes of the vertical contour of the foot.

### BACKGROUND OF THE INVENTION

1. Field of the Invention

The disclosed embodiments relate in general to the field of software application technology and in particular to method for shoe fitting and particularly to determining the size of the foot using image recognition.

2. Description of the Related Art

Internet shops of footwear are interested in decreasing percentage of purchase return (because of not compliances of the size) after footwear delivery to the client. It can be reached by means of virtual fitting. For its performance the client has to execute measurements of the specific sizes of his foot and transmit them through on-line service to the Internet shop. Disadvantage of such approach is the insufficient accuracy of measurements by means of measuring tools available to the client.

Therefore, new and improved technology for using photos of a foot for determination of its specific sizes is needed.

### SUMMARY OF THE INVENTION

The inventive methodology is directed to methods and systems that substantially obviate one or more of the above and other problems associated with conventional technology.

In accordance with one aspect of the embodiments described herein, there is provided a computer-implemented method for estimating a size of a foot, the computer-implemented method being performed in connection with a computer system comprising a central processing unit and a memory, the computer-implemented method comprising: receiving a plurality of images of the foot in relation to a sheet of paper; performing determination of a contour of the sheet of paper in the received plurality of images; using at least one of the received plurality of images to determine an internal contour of the foot; using at least second one of the received plurality of images to determine an external contour of the foot; using the determined internal contour of the foot and the determined external contour of the foot to calculate a horizontal contour of the foot and calculate a size of the horizontal contour of the foot; and using at least third one of the received plurality of images to determine an vertical contour of the foot and calculate a sizes of the vertical contour of the foot.

In one or more embodiments, the plurality of images comprises three images.

In one or more embodiments, the method further comprises refining the horizontal contour of the foot using an edgemap.

In one or more embodiments, refining the horizontal contour of the foot further comprises: building the edgemap; removing short edges from the edgemap; performing special scaling of an image of the plurality of images; finding a plurality of closed contours; and choosing a demanded contour from the plurality of closed contours.

In one or more embodiments, the sheet of paper is a standard sheet of paper.

In one or more embodiments, the method further comprises calculating scaling parameters.

In accordance with another aspect of the embodiments described herein, there is provided a non-transitory computer-readable medium comprising a set of instructions, which, when executed in connection with a computer system comprising a central processing unit and a memory, cause the computer system to perform a method for estimating a size of a foot, the method comprising: receiving a plurality of images of the foot in relation to a sheet of paper; performing determination of a contour of the sheet of paper in the received plurality of images; using at least one of the received plurality of images to determine an internal contour of the foot; using at least second one of the received plurality of images to determine an external contour of the foot; using the determined internal contour of the foot and the determined external contour of the foot to calculate a horizontal contour of the foot and calculate a size of the horizontal contour of the foot; and using at least third one of the received plurality of images to determine an vertical contour of the foot and calculate a sizes of the vertical contour of the foot.

In one or more embodiments, the plurality of images comprises three images.

In one or more embodiments, the method further comprises refining the horizontal contour of the foot using an edgemap.

In one or more embodiments, refining the horizontal contour of the foot further comprises: building the edgemap; removing short edges from the edgemap; performing special scaling of an image of the plurality of images; finding a plurality of closed contours; and choosing a demanded contour from the plurality of closed contours.

In one or more embodiments, the sheet of paper is a standard sheet of paper.

In one or more embodiments, the method further comprises calculating scaling parameters.

In accordance with yet another aspect of the embodiments described herein, there is provided a computerized system comprising a central processing unit and a memory, the memory storing a set of instructions, which, when executed in connection with a cause the computerized system to perform a method for estimating a size of a foot, the method comprising: receiving a plurality of images of the foot in relation to a sheet of paper; performing determination of a contour of the sheet of paper in the received plurality of images; using at least one of the received plurality of images to determine an internal contour of the foot; using at least second one of the received plurality of images to determine an external contour of the foot; using the determined internal contour of the foot and the determined external contour of the foot to calculate a horizontal contour of the foot and calculate a size of the horizontal contour of the foot; and using at least third one of the received plurality of images to determine an vertical contour of the foot and calculate a sizes of the vertical contour of the foot.

In one or more embodiments, the plurality of images comprises three images.

In one or more embodiments, the method further comprises refining the horizontal contour of the foot using an edgemap.

In one or more embodiments, refining the horizontal contour of the foot further comprises: building the edgemap; removing short edges from the edgemap; performing special scaling of an image of the plurality of images; finding a plurality of closed contours; and choosing a demanded contour from the plurality of closed contours.

In one or more embodiments, the sheet of paper is a standard sheet of paper.

In one or more embodiments, the method further comprises calculating scaling parameters.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 shows an example photo of horizontal and vertical contours of foot;

FIG. 2 shows an example photo of internal part of a horizontal contour of foot;

FIG. 3 shows an example photo of external part of a horizontal contour of foot;

FIG. 4 shows an example photo of vertical contour of foot;

FIG. 5 shows a schematic depiction of the method of the present invention;

FIG. 6 shows a schematic depiction of the foot contours reconstruction used in the method;

FIG. 7 shows designations and the coordinate systems used at recognition of contours;

FIG. 8 shows the designations used at calculation of contour image scales.

FIG. 9 illustrates an exemplary embodiment of a server platform upon which the described embodiments may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

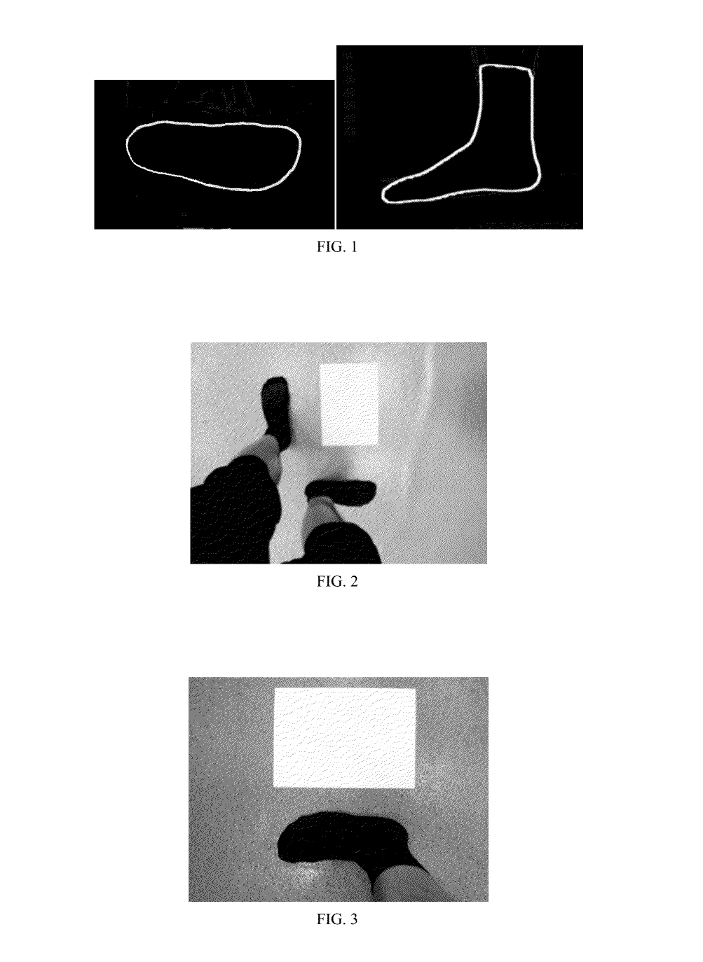

The specific sizes of foot are understood as its contour in the horizontal plane and the contour of the vertical section passing through the center of a heel and a thumb (FIG. 1) and also scales of images of these contours. Input data for receiving contours are three photos (FIG. 2-4) shot by a camera with the resolution not less than 2 megapixels according to the listed below requirements.

The first and the second photos should contain white sheet of A4 or Letter format paper and the right foot in a black sock. Color of a background should be much lighter than black, but not white. One of these photos should contain internal part of foot, and another—external one. These photos should be made by horizontally positioned camera. The third photo should contain internal part of foot made by vertically positioned camera. One of paper sheet edges and foot should be oriented in parallel to the upper edge of photos.

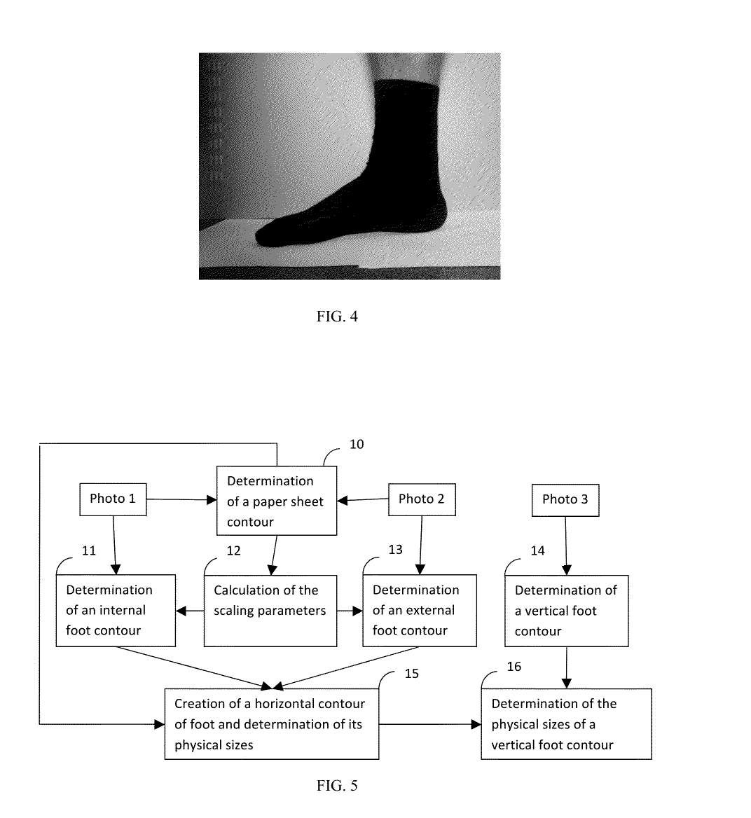

According to FIG. 5, the first two photos are processed in blocks 10, 11 and 13. The block 10 serves for determination of the paper sheet contour on the photos. This contour is used in the block 12 for calculation of the linear sizes of pixels in considered photos by the known linear sizes of the sheet of paper. The knowledge of the linear sizes of pixels is used for determination of internal and external contours of foot in blocks 11 and 13. These contours are united in a unified contour in block 15. The physical length of the horizontal foot contour is calculated in the same block by means of one of paper sheet contour. This length is used in the block 16 for determination of the physical sizes of the vertical contour of the foot, which is determined in the block 14 by the third photo.

Determination of contours is carried out in compliance of FIG. 6. Edge Map is built by Canny algorithm in the block 20. Algorithm parameters are selected so that to guarantee preservation of significant details. Generation of a large number of short edges which removal is carried out in the block 21 by means of the following morphological operation is a consequence of such strategy. Each pixel of the image is surrounded with a rectangle, and for all rectangle perimeter pixels their values are compared with zero. If all pixels of the perimeter have zero value, in such rectangle there are no pixel relating to significant edges, and zero values can be assigned to all internal pixels of the rectangle.

The purpose of special image scaling (which is carried out in the block 22) is the exception of gaps in required contours. It is reached by replacement of each window of 8×8 in size of the initial image by one pixel with the value equal to the maximum value among pixels in this window. The resultant image is used in the block 23 for finding a set of the closed contours from which the required contour is determined in the block 24, by check of each element of the set for compliance to certain criteria. These criteria depend on a the shape of required contour.

The following criteria are applied for search of a contour of the sheet of paper (block 10):
The contour should have a quadrangle shape
Length of its greatest edge should exceed ¼long edge of the photo.
Ratio of lengths of adjacent edges of the quadrangle is approximately equal to the same of the sheet of paper.

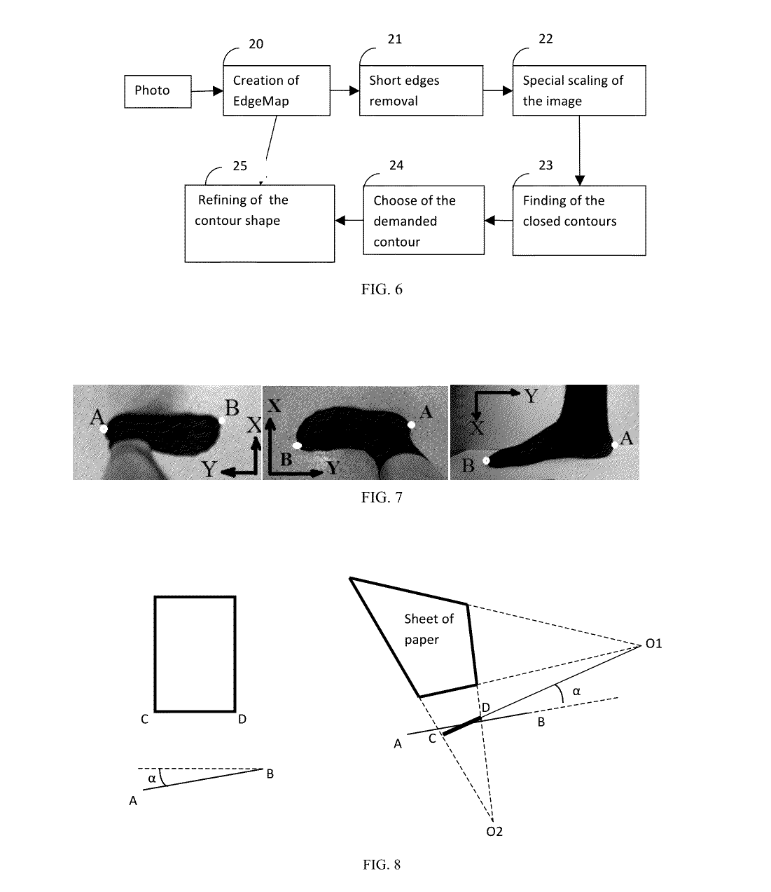

The main criterion for searching contours of the foot is existence of two points: A and B, which are the ends of the heel and the toe according to FIG. 7. When the analysis of contours in XY coordinate systems (shown on FIG. 7) is made, A point is found as a point in which the first local maximum is reached at counterclockwise travers of the top half of the contour. B point is determined as a contour point the most remote from A in 60 degrees sector directed against Y axis. Additional criteria are:
AB segment shouldn't have internal crossings with the contour.
Length of AB segment has to be within the limits of possible lengths of feet.

To check the last criteria the length of AB piece in pixels is converted to millimeters by multiplication by the scale calculated in the block 12.

Elaboration of the contour shape (block 25) is carried out by means of the Active contour algorithm. According to this algorithm the contour is approximated by a polygon and transferred to EdgeMap received in the block 20. The polygon extends by movement of each Mvertex in the direction of its external normal until crossing of one of the pieces, connected with top, with an edge in EdgeMap is detected. For ensuring smoothness of a resultant contour, new vertices can be generated in the course of expansion of a polygon, if the corner between the adjacent segments is less than the specified threshold. The formal algorithm description is given below.

To create the polygon inscribed in a contour;
While (though one vertex of a polygon is moved)
{
For (all vertices)

{

While (there is no crossing with EdgeMap edges)
To move the vertex;

If (the corner between the segments connected with the vertex is

less than the threshold)

To create new vertices in the polygon;
}
}

Creation of a horizontal contour of the foot in the block 15 is carried out by merging external and internal contours according to the following algorithm:
To execute scaling of the external contour so that the length of AB segment of this contour coincides with the length of the same segment of the internal contour;
To superpose these segments;
To minimize jumps of derivatives in points of contours superposition by rotation of external contour around the center of AB segment;
To remove the part of the external contour located above superposition points;
To remove the part of the internal contour located below superposition points.

The physical sizes of contours are defined by scales of their images. For determination of the horizontal contour scale in the block 15, the sheet of paper contour received from the first photo is used. L value—length of a horizontal contour of foot—is calculated on the formula:

L=w*|AB|/(|CD|*cos(α)) (1)

where w—width of the sheet of paper in millimeters, α—corner between AB and CD segments (FIG. 8), |AB| [symbol] |CD|—lengths of AB and CD segments respectively in pixels. If the contour of the sheet of paper has a rectangular shape, then CD is the bottom segment of this contour (FIG. 8 at the left). If this contour is not of rectangular shape (owing to perspective distortions which arise if the camera is positioned not strictly horizontally), then CD is the segment passing through O1 point (FIG. 7 on the right) and the center of AB segment between straight lines, being continuation of lateral edges of the sheet of paper. The scale of the image m is given by the ratio:

m=L/|AB|

This formula is used also in the block 16 for determination of scale of the vertical contour. L value is transmitted to this block from the block 15, and |AB| value—from the block 14.

If requirements for proper camera positioning are not met during photography, some perspective distortions of the foot contour may appear. The formula (1) considers such distortions at determination of the length of the foot, however the contour remains distorted. It generates errors at calculation of contour width and height. Maximum relative error value δis:

δ=1−cos φ

Where φ is a corner of the camera deviation from the demanded position. The maximum absolute error, for example, for the foot of 100 mm wide at camera inclination of 10 degrees reaches 1.5 mm.

The absolute errors connected with limited photo resolution are less than 1 mm for a 2-megapixel camera.

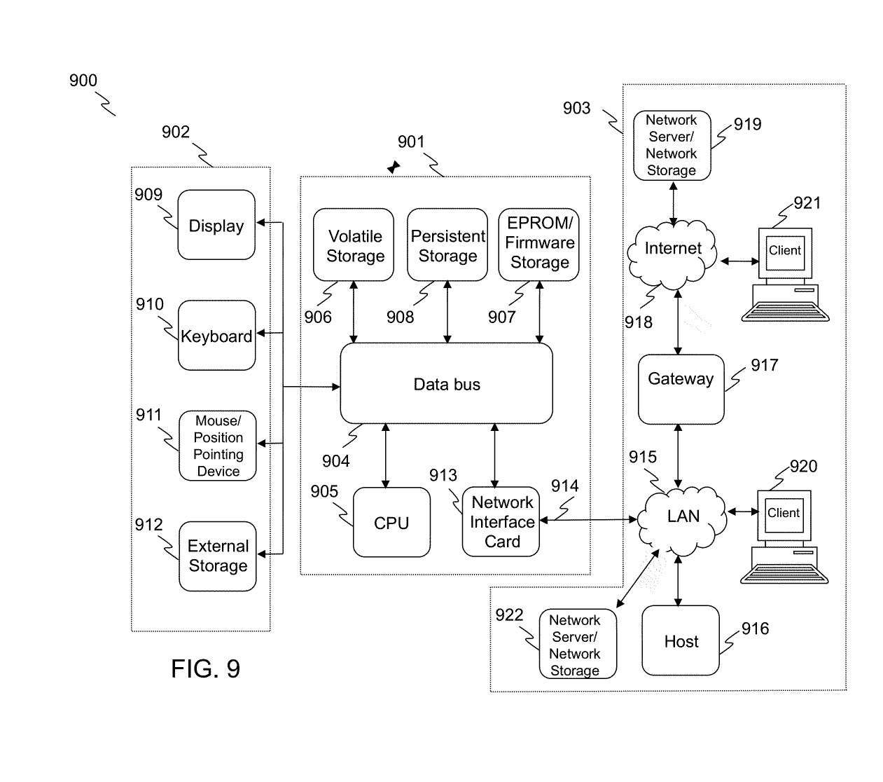

FIG. 9 illustrates an exemplary embodiment of a computer platform upon which the inventive system may be implemented. Specifically, FIG. 9 represents a block diagram that illustrates an embodiment of a computer/server system 900 upon which an embodiment of the inventive methodology may be implemented. The system 900 includes a computer/server platform 901, peripheral devices 902 and network resources 903.

In one or more embodiments, the computer platform 901 may include a data bus 904 or other communication mechanism for communicating information across and among various parts of the computer platform 901, and a processor 905 coupled with bus 904 for processing information and performing other computational and control tasks. Computer platform 901 also includes a volatile storage 906, such as a random access memory (RAM) or other dynamic storage device, coupled to bus 904 for storing various information as well as instructions to be executed by processor 905. The volatile storage 906 also may be used for storing temporary variables or other intermediate information during execution of instructions by processor 905. Computer platform 901 may further include a read only memory (ROM or EPROM) 907 or other static storage device coupled to bus 904 for storing static information and instructions for processor 905, such as basic input-output system (BIOS), as well as various system configuration parameters. A persistent storage device 908, such as a magnetic disk, optical disk, or solid-state flash memory device is provided and coupled to bus 904 for storing information and instructions.

Computer platform 901 may be coupled via bus 904 to a display 909, such as a cathode ray tube (CRT), plasma display, or a liquid crystal display (LCD), for displaying information to a system administrator or user of the computer platform 901. An input device 910, including alphanumeric and other keys, is coupled to bus 904 for communicating information and command selections to processor 905. Another type of user input device is cursor control device 911, such as a mouse, a trackball, or cursor direction keys for communicating direction information and command selections to processor 905 and for controlling cursor movement on display 909. This input device typically has two degrees of freedom in two axes, a first axis (e.g., x) and a second axis (e.g., y), that allows the device to specify positions in a plane.

An external storage device 912 may be coupled to the computer platform 901 via bus 904 to provide an extra or removable storage capacity for the computer platform 901. In an embodiment of the computer system 900, the external removable storage device 912 may be used to facilitate exchange of data with other computer systems.

The invention is related to the use of computer system 900 for implementing the techniques described herein. In an embodiment, the inventive system may reside on a machine such as computer platform 901. According to one embodiment of the invention, the techniques described herein are performed by computer system 900 in response to processor 905 executing one or more sequences of one or more instructions contained in the volatile memory 906. Such instructions may be read into volatile memory 906 from another computer-readable medium, such as persistent storage device 908. Execution of the sequences of instructions contained in the volatile memory 906 causes processor 905 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 905 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 908. Volatile media includes dynamic memory, such as volatile storage 906.

Common forms of computer-readable media include, for example, a floppy disk, a flexible disk, hard disk, magnetic tape, or any other magnetic medium, a CDROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 905 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infrared transmitter to convert the data to an infra-red signal. An infra-red detector can receive the data carried in the infra-red signal and appropriate circuitry can place the data on the data bus 904. The bus 904 carries the data to the volatile storage 906, from which processor 905 retrieves and executes the instructions. The instructions received by the volatile memory 906 may optionally be stored on persistent storage device 908 either before or after execution by processor 905. The instructions may also be downloaded into the computer platform 901 via Internet using a variety of network data communication protocols well known in the art.

The computer platform 901 also includes a communication interface, such as network interface card 913 coupled to the data bus 904. Communication interface 913 provides a two-way data communication coupling to a network link 915 that is coupled to a local network 915. For example, communication interface 913 may be an integrated services digital network (ISDN) card or a modem to provide a data communication connection to a corresponding type of telephone line. As another example, communication interface 913 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 913 sends and receives electrical, electromagnetic or optical signals that carry digital data streams representing various types of information.

Network link 914 typically provides data communication through one or more networks to other network resources. For example, network link 914 may provide a connection through local network 915 to a host computer 916, or a network storage/server 917. Additionally or alternatively, the network link 914 may connect through gateway/firewall 917 to the wide-area or global network 918, such as an Internet. Thus, the computer platform 901 can access network resources located anywhere on the Internet 918, such as a remote network storage/server 919. On the other hand, the computer platform 901 may also be accessed by clients located anywhere on the local area network 915 and/or the Internet 918. The network clients 920 and 921 may themselves be implemented based on the computer platform similar to the platform 901.

Local network 915 and the Internet 918 both use electrical, electromagnetic or optical signals that carry digital data streams. The signals through the various networks and the signals on network link 915 and through communication interface 913, which carry the digital data to and from computer platform 901, are exemplary forms of carrier waves transporting the information.

Computer platform 901 can send messages and receive data, including program code, through the variety of network(s) including Internet 918 and LAN 915, network link 915 and communication interface 913. In the Internet example, when the system 901 acts as a network server, it might transmit a requested code or data for an application program running on client(s) 920 and/or 921 through Internet 918, gateway/firewall 917, local area network 915 and communication interface 913. Similarly, it may receive code from other network resources.

The received code may be executed by processor 905 as it is received, and/or stored in persistent or volatile storage devices 908 and 906, respectively, or other non-volatile storage for later execution.

It should be understood that processes and techniques described herein are not inherently related to any particular apparatus and may be implemented by any suitable combination of software components. Further, various types of general purpose software components may be used in accordance with the teachings described herein. It may also prove advantageous to extend the taxonomy as well as number of media Channels and Channel Actions to perform the method steps described herein. The present invention has been described in relation to particular examples, which are intended in all respects to be illustrative rather than restrict. Those skilled in the art will appreciate that many different combinations of software components, and software services will be suitable for practicing the present invention. For example, the described software may be implemented in a wide variety of programming or scripting languages, such as .NET, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized systems and computer-implemented methods for foot size estimation. It is intended that the specification and examples be considered as exemplary only, with a true scope and spirit of the invention being indicated by the following claims.

What is claimed is:

1. A computer-implemented method for estimating a size of a foot, the computer-implemented method being performed in connection with a computer system comprising a central processing unit and a memory, the computer-implemented method comprising:
a. receiving a plurality of images of the foot in relation to a sheet of paper;
b. performing determination of a contour of the sheet of paper in the received plurality of images;
c. using at least one of the received plurality of images to determine an internal contour of the foot;
d. using at least second one of the received plurality of images to determine an external contour of the foot;
e. using the determined internal contour of the foot and the determined external contour of the foot to calculate a horizontal contour of the foot and calculate a size of the horizontal contour of the foot; and
f. using at least third one of the received plurality of images to determine an vertical contour of the foot and calculate a sizes of the vertical contour of the foot.

2. The computer-implemented method of claim 1, wherein the plurality of images comprises three images.

3. The computer-implemented method of claim 1, further comprising refining the horizontal contour of the foot using an edgemap.

4. The computer-implemented method of claim 3, wherein refining the horizontal contour of the foot further comprises:
i. building the edgemap;
ii. removing short edges from the edgemap;
iii. performing special scaling of an image of the plurality of images;
iv. finding a plurality of closed contours; and
v. choosing a demanded contour from the plurality of closed contours.

5. The computer-implemented method of claim 1, wherein the sheet of paper is a standard sheet of paper.

6. The computer-implemented method of claim 1, further comprising calculating scaling parameters.

7. A non-transitory computer-readable medium comprising a set of instructions, which, when executed in connection with a computer system comprising a central processing unit and a memory, cause the computer system to perform a method for estimating a size of a foot, the method comprising:
a. receiving a plurality of images of the foot in relation to a sheet of paper;
b. performing determination of a contour of the sheet of paper in the received plurality of images;
c. using at least one of the received plurality of images to determine an internal contour of the foot;
d. using at least second one of the received plurality of images to determine an external contour of the foot;
e. using the determined internal contour of the foot and the determined external contour of the foot to calculate a horizontal contour of the foot and calculate a size of the horizontal contour of the foot; and
f. using at least third one of the received plurality of images to determine an vertical contour of the foot and calculate a sizes of the vertical contour of the foot.

8. The non-transitory computer-readable medium of claim 7, wherein the plurality of images comprises three images.

9. The non-transitory computer-readable medium of claim 7, wherein the method further comprises refining the horizontal contour of the foot using an edgemap.

10. The non-transitory computer-readable medium of claim 9, wherein refining the horizontal contour of the foot further comprises:
i. building the edgemap;
ii. removing short edges from the edgemap;
iii. performing special scaling of an image of the plurality of images;
iv. finding a plurality of closed contours; and
v. choosing a demanded contour from the plurality of closed contours.

11. The non-transitory computer-readable medium of claim 7, wherein the sheet of paper is a standard sheet of paper.

12. The non-transitory computer-readable medium of claim 7, wherein the method further comprises calculating scaling parameters.

13. A computerized system comprising a central processing unit and a memory, the memory storing a set of instructions, which, when executed in connection with a cause the computerized system to perform a method for estimating a size of a foot, the method comprising:
a. receiving a plurality of images of the foot in relation to a sheet of paper;
b. performing determination of a contour of the sheet of paper in the received plurality of images;
c. using at least one of the received plurality of images to determine an internal contour of the foot;
d. using at least second one of the received plurality of images to determine an external contour of the foot;
e. using the determined internal contour of the foot and the determined external contour of the foot to calculate a horizontal contour of the foot and calculate a size of the horizontal contour of the foot; and
f. using at least third one of the received plurality of images to determine an vertical contour of the foot and calculate a sizes of the vertical contour of the foot.

14. The computerized system of claim 13, wherein the plurality of images comprises three images.

15. The computerized system of claim 7, wherein the method further comprises refining the horizontal contour of the foot using an edgemap.

16. The computerized system of claim 15, wherein refining the horizontal contour of the foot further comprises:
i. building the edgemap;
ii. removing short edges from the edgemap;
iii. performing special scaling of an image of the plurality of images;
iv. finding a plurality of closed contours; and
v. choosing a demanded contour from the plurality of closed contours.

17. The computerized system of claim 7, wherein the sheet of paper is a standard sheet of paper.

18. The computerized system of claim 7, wherein the method further comprises calculating scaling parameters.
